(19) United States
(12) Patent Application Publication
(10) Pub. No.: US 2023/0123535 A1
(43) Pub. Date: Apr. 20, 2023

(54) ONLINE MACHINE LEARNING-BASED DIALOGUE AUTHORING ENVIRONMENT

(71) Applicant: Microsoft Technology Licensing, LLC, Redmond, WA (US)

(72) Inventors: William B. DOLAN, Kirkland, WA (US); Gabriel A. DESGARENNES, Issaquaah, WA (US); Christopher John BROCKETT, Kirkland, WA (US); Hamid PALANGI, Bellevue, WA (US); Ryan VOLUM, Seattle, WA (US); Sudha RAO, Bothell, WA (US); Yun Hui XU, Phoenix, AZ (US); Akanksha MALHOTRA, Bellevue, WA (US); Benjamin David VAN DURME, Baltimore, MD (US)

(73) Assignee: Microsoft Technology Licensing, LLC, Redmond, WA (US)

(21) Appl. No.: 17/959,706

(22) Filed: Oct. 4, 2022

Related U.S. Application Data
(60) Provisional application No. 63/255,796, filed on Oct. 14, 2021.
(60) Provisional application No. 63/345,216, filed on May 24, 2022.

(51) Int. Cl. G06N 20/00; G06F 40/35

(52) U.S. Cl. CPC G06N 20/00; G06F 40/35

(57) ABSTRACT

In examples, a developer may define a set of computer-controlled agent attributes, which may be processed by a generative multimodal machine learning model in conjunction with background information associated with a virtual environment (e.g., “lore”) and other agent information to generate multimodal model output with which to control the behavior of the computer-controlled agent. Thus, a player may interact with the computer-controlled agent, such that user input from the player is processed using the ML model to generate model output to affect the behavior of the computer-controlled agent, thereby enabling the user and the computer-controlled agent to interact. As compared to manual dialogue authoring, use of agent information to define the behavior of a computer-controlled agent may result in reduced effort on the part of a creator while also offering increased depth and variety for computer-controlled agents of a virtual environment.

### CROSS-REFERENCE TO RELATED APPLICATIONS

This application claims priority to U.S. Provisional Application No. 63/345,216, filed May 24, 2022, titled “Creation and Personalization of Virtual Gamers” and U.S. Provisional Application No. 63/255,796, filed Oct. 14, 2021, titled “Grounded Multimodal Agent Interactions” the entire disclosures of which are hereby incorporated herein by reference.

### BACKGROUND

Traditionally, manually authoring dialogue for non-player characters (NPCs) of a virtual environment has been a time-consuming, potentially tedious, and expensive process. Further, the amount of effort associated with NPC dialogue may serve as a limiting factor to the amount, depth, and/or variability of NPC storylines that are included in the virtual environment, thus resulting in a user experience that is unnecessarily limited.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to an online machine learning-based dialogue authoring environment. In examples, a developer may define a set of computer-controlled agent attributes, which may be processed by a generative multimodal machine learning model in conjunction with background information associated with a virtual environment (e.g., “lore”) and other agent information to generate multimodal model output with which to control the appearance and/or behavior of the computer-controlled agent.

Thus, a player may interact with the computer-controlled agent, such that user input from the player is processed using the ML model to generate model output to affect the computer-controlled agent, thereby enabling the user and the computer-controlled agent to interact. As compared to manual dialogue authoring, use of agent information to define aspects of the computer-controlled agent may result in reduced effort on the part of a creator while also offering increased depth and variety for computer-controlled agents of a virtual environment.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system in which an online machine learning-based dialogue authoring environment may be used according to aspects of the present disclosure.

FIG. 2 illustrates an overview of an example conceptual diagram for generating machine learning-based dialogue according to aspects described herein.

FIG. 3 illustrates an overview of an example method for generating agent information with which to manage an agent of a virtual environment according to aspects described herein.

FIG. 4 illustrates an overview of an example method for managing an agent for a virtual environment according to aspects described herein.

FIG. 5 illustrates an overview of an example method for managing an agent for a virtual environment at a cloud service according to aspects described herein.

FIG. 6 is a block diagram illustrating example physical components of a computing device with which aspects of the disclosure may be practiced.

FIG. 7 is a simplified block diagram of a mobile computing device with which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a computer-controlled agent (e.g., a non-player character or bot) may exist within a virtual environment, such that a user may interact with the computer-controlled agent. For example, the user may encounter the agent as a non-player character (NPC) in a video game, such that the user may correspond with or otherwise interact with the NPC. The NPC may advance a plot of the video game and/or may affect a certain outcome within the virtual environment (e.g., an exchange of one or more items or a branch in a storyline), among other examples. However, such agent interactions are typically manually created by a video game developer or other content creator, resulting in increased development costs, frustration from tedious and potentially repetitive manual operations, lack of variety across NPCs, and/or the potential for human error, among other detriments.

Accordingly, aspects of the present disclosure relate to an online machine learning-based dialogue authoring environment. In examples, a generative multimodal machine learning (ML) model processes user input to generate multimodal output. For example, a computer-controlled agent according to aspects described herein may receive user input, such that the user input may be processed using the generative multimodal ML model to generate multimodal output. The ML model may be finetuned or aspects of the ML model may otherwise be defined and/or restricted by a developer or creator for a given computer-controlled agent, such that the ML model may be used to generate multimodal output when a player interacts with the computer-controlled agent within the virtual environment. Thus, as compared to manual dialogue authoring (e.g., where a creator manually authors various dialogue exchanges for an NPC), aspects of the present disclosure enable a developer to control the generative behavior of an ML model for any number of computer-controlled agents, such that model output is generated and used to interact with a player accordingly. Further, through reinforcement learning, certain model outputs may be “solidified” or may otherwise have an increased incidence for a given user interaction (e.g., having an associated positive outcome; as may be associated with certain dialogue paths/branches). It will be appreciated that the same ML model may be used to generate model output for any number of computer-controlled agents. Additionally, as used herein, a “user” may refer to a player, a developer, or a creator, among other examples. In still further examples, the authoring environment may incorporate or take the form of a computer-controlled agent, conversational agent, or other type of digital agent.

Multimodal output generated by an ML model according to aspects of the present disclosure may comprise natural language output and/or programmatic output, among other examples. The multimodal output may be processed and used to affect the state of an associated application, such as a video game application or other virtual environment. For example, at least a part of the programmatic output may be executed or may be used to call an application programming interface (API) of the application. A generative multimodal ML model (also generally referred to herein as a multimodal ML model) used according to aspects described herein may be a generative transformer model, in some examples. Example ML models include, but are not limited to, the BigScience Large Open-science Open-access Multilingual Language Model (BLOOM), DALL-E, DALL-E 2, or Jukebox. In some instances, explicit and/or implicit feedback may be processed to improve the performance of multimodal machine learning model. In further examples, the generative multimodal ML model is operable to generate virtual objects in the virtual environment, computer executable code capable of generating, modifying, or controlling object or characters in the virtual environment, or the like. That is, the generative multimodal model may also function as a code generation model which generates executable code or programmatic content for the virtual environment or associated application. In examples, the authoring environment may include multiple machine learning models, e.g., a generative model, a code generation model, a text generation model, a conversational model, a virtual object generation model, or the like. Alternatively, or additionally, the authoring environment may include a foundational model.

In examples, user input and/or model output is multimodal, which, as used herein, may comprise one or more types of content. Example content includes, but is not limited to, spoken or written language (which may also be referred to herein as “natural language output”), code (which may also be referred to herein as “programmatic output”), images, video, audio, gestures, visual features, intonation, contour features, poses, avatars, player models, skins, styles, fonts, and/or transitions, among other examples. Thus, as compared to a machine learning model that processes natural language input and generates natural language output, aspects of the present disclosure may process input and generate output having any of a variety of content types.

To create a computer-controlled agent with which a player can interact, a developer may define any of a variety of agent attributes. Example agent attributes include, but are not limited to, one or more agent traits, an agent persona, one or more agent goals, and/or an agent mood. In examples, agent attributes may be defined using a prompt or, as another example, different prompts may indicate different attributes. For instance, a first prompt may indicate a set of persona goals for the computer-controlled agent, while a second prompt may indicate one or more scene goals for the computer-controlled agent. Thus, as a player progresses within a virtual environment, different prompts, virtual environment state information, and/or associated agent attributes may be used to produce model output with which a computer-controlled agent is controlled.

The agent attributes may form at least a part of the agent information that is processed (e.g., using a generative ML model) to generate model output according to aspects described herein. For example, agent information may also include background information associated with the virtual environment (e.g., “lore” for a video game application, virtual environment context, and/or API documentation, among other information sources). As another example, the agent information may also include historical information associated with a player (e.g., past interactions between the player and the computer-controlled agent or past decisions made by the player) and/or a set of player attributes (e.g., a trait of the player, a persona of the player, a goal of the player, and/or a mood of the player). As another example, virtual environment state information may be used, which may indicate a state of a player inventory, characteristics of a player (e.g., a health level and/or an experience level), aspects of the virtual environment that have changed as a result of user interaction(s) (e.g., changes to available environmental resources or interactions with other computer-controlled agents), and/or one or more player preferences. Thus, such additional information may further ground the generative ML model and may therefore enable the ML model to generate model output that has increased relevance to the virtual environment and/or a memory of the player's experiences within the virtual environment.

In examples, a user interface is provided with which a user may define agent information. For example, the user interface may include one or more text input elements that are each associated with a set of agent attributes, such that the user may input a prompt or other information for such agent attributes. As another example, a user may author a story from which model output may be generated. While examples are described in which a developer creates a computer-controlled agent with which a player may interact, it will be appreciated that, in other examples, the developer and the player may each be the same user. For instance, a user may author a story for a computer-controlled agent, such that the child may interact with the resulting computer-controlled agent within the virtual environment accordingly. The user may interact with the virtual environment and/or a computer-controlled agent within the virtual environment when defining and/or changing agent information. For example, the user may play a video game and may use such a user interface to alter NPC attributes to tune the appearance and/or behavior of the NPC, and/or to adjust aspects of the NPC as the video game progresses.

A developer may change agent information in any of a variety of scenarios. For example, agent information may be updated when the developer determines that the computer-controlled agent is not behaving as intended, such that the agent information may be changed to indicate different agent attributes, include different background information, reference different historical information and/or player attributes, and/or reflect a different virtual environment state, among other examples. As another example, the agent information may be changed in association with aspects of a virtual environment, such as in association with a given scene, map, or location within the virtual environment, or in association with a set of conditions. In examples, a computer-controlled agent may be defined based on a target virtual environment state that will be achieved if a set of computer-controlled agent goals are achieved, such that agent information may be updated in response to identifying such a target virtual environment state. Thus, agent information may change throughout user interactions with the virtual environment according to a set of criteria and/or based on one or more rules, among other constraints. Similarly, it will be appreciated that such changes may be associated with branching logic, as may be case when an implicit and/or explicit user interaction indicates a choice to advance down a different branch of a storyline in the virtual environment.

While examples are described in which the multimodal output includes natural language output (e.g., dialogue for the computer-controlled agent) and/or programmatic output (e.g., to control aspects of the computer-controlled agent and/or aspects of the virtual environment), it will be appreciated that multimodal output may include any of a variety of other content types in other examples. For example, the multimodal output may affect the appearance of the computer-controlled agent and/or the appearance of a scene within the virtual environment. As another example, the multimodal output may include one or more images, animations, avatars, player models, skins, and/or audio tracks, among other examples.

In examples, a model repository is provided, which may store preexisting instances of agent information, agent templates, and/or associated ML models (e.g., that are finetuned for a given context) from which a computer-controlled agent may be created. As another example, aspects of the present disclosure may enable the use of a computer-controlled agent across multiple virtual environments, as may be the case when at least some agent information is common to instances of a computer-controlled agent in multiple virtual environments (e.g., different installments in a video game franchise or virtual environments associated with various productivity tasks). As a further example, agent information may be tweaked or may otherwise diverge between a plurality of computer-controlled agents, thereby yielding a set of computer-controlled agents with certain similarities (e.g., a common goal or a shared history) while still offering diversity, as may be desirable for a village or other social environment within a virtual environment.

As noted above, a generative ML model may be used to generate model output associated with a computer-controlled agent according to aspects described herein. In examples, the ML model may be a general model that is used to generate model output for any of a variety of contexts (e.g., multiple virtual environments and/or multiple computer-controlled agents). As another example, the ML model may be finetuned for a specific context, for example based on background information and/or historical user interactions associated with a given set of virtual environments and/or computer-controlled agents, among other examples.

AB testing may be used to test different instances of agent information for a given computer-controlled agent and/or different associated ML models. For example, a first set of users may interact with a computer-controlled agent that is operating using model output generated based on a first instance of agent information, while a second set of users interact with another computer-controlled agent that operates using model output that was generated based on a second instance of agent information. Associated outcomes may be evaluated based on implicit and/or explicit feedback (e.g., an explicit indication of user satisfaction and/or an amount of time associated with achieving a certain result), such that a determination may ultimately be made between the first instance or second instance of agent information.

Thus, the appearance and/or behavior of a computer-controlled agent within a virtual environment may be tweaked based on changes to the agent information and/or the ML model with which model output is generated. Additionally, as a result of changing or upgrading the ML model, new or different interactions may be enabled for a given computer-controlled agent. Such changes may have little to no associated involvement on the part of a virtual environment developer, and, similarly, associated agent information may be used with an updated ML model substantially as-is. In contrast to manually defined, rigid dialogue, aspects of the present disclosure enable a computer-controlled agent to interactions that are comparatively more dynamic and that may further be comparatively easier to define (given a developer need not define every aspect of the resulting dialogue).

In examples, model output may be further constrained to reduce the likelihood of unexpected agent behavior and/or undesirable user interactions. For example, model output may be evaluated prior to implementation by a computer-controlled agent. The evaluation may comprise evaluating the model output according to a set of rules, patterns, and/or filters, among other examples. In examples, the evaluation may be dependent on the virtual environment for which the model output was generated. As an example, the evaluation may vary according to an associated rating or intended audience of the virtual environment. In instances where the model output does not pass the evaluation (e.g., it is determined that the model output is not relevant to the context for which it was generated and/or the model output includes objectionable content), additional model output may be generated. The additional model output may be a next highest ranked candidate generated by the ML model or, as another example, alternative agent information may be used to tweak the resulting output accordingly.

As an alternative to, or in addition to, such explicit constraints, the use of reinforcement learning as described herein may similarly serve to refine the appearance and/or behavior of a computer-controlled agent. For instance, model output that is associated with positive user feedback may be used to update agent information and/or finetune an associated ML model, thereby increasing the incidence that similar model output is generated in the future. Conversely, model output that is not favorably received may be gradually trained out of the resulting model output. Thus, model performance for a given set of agent information and associated user interactions may gradually converge to generate a set of model outputs that result in generally favorable user interactions.

While aspects of the present disclosure are described in examples where a computer-controlled agent is controlled according to agent information within a video game or other virtual environment, it will be appreciated that the described aspects are applicable in any of a variety of other domains. For instance, a computer-controlled agent may be provided that facilitates task-oriented dialogue that is generated based on agent information according to aspects described herein, thereby enabling a user to interact with the computer-controlled agent to work toward a pre-defined goal and/or state. Further, while for clarity of explanation aspects of the present disclosure have been described with respect to a video game or other virtual environment, aspects disclosed herein may be practiced with other types of applications and in other environments, such as educational applications, productivity applications, online or web-based applications, or the like. For example, aspects of the present application can be used to generate actions or dialog for instructional agents in an educational application or on an educational platform, helper agents that are part of an enterprise application or platform, customer service agents on a website or mobile application, etc. One of skill in the art will appreciate that a computer-controlled agent, as used herein, may refer to a non-player character in a video game, a digital assistant on a mobile device or that is part of a website or mobile application, a digital customer service agent, a digital educational assistant that is part of an educational application or educational platform, a digital productivity assistant that is part of an enterprise platform, enterprise application, or content creation application, or the like. That is, aspects of the present disclosure are not limited to being employed in a video game or virtual environment, rather, the aspects disclosed herein can be practiced with other types of applications without departing from the scope of this disclosure.

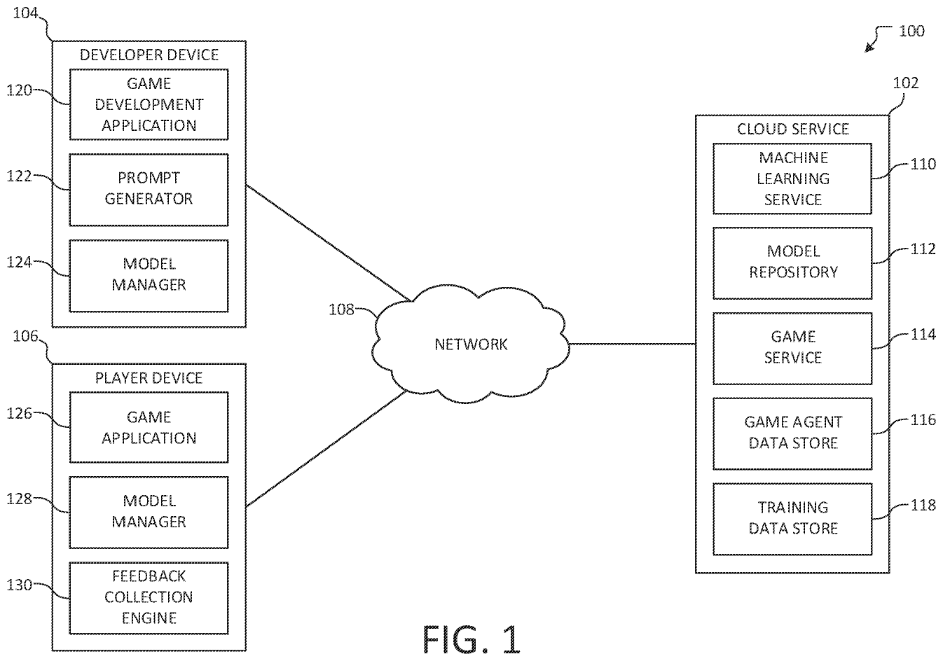

FIG. 1 illustrates an overview of an example system 100 in which an online machine learning-based dialogue authoring environment may be used according to aspects of the present disclosure. As illustrated, system 100 includes cloud service 102, developer device 104, player device 106, and network 108. In examples, cloud service 102, developer device 104, and/or player device 106 may communicate via network 108, which may comprise a local area network, a wireless network, or the Internet, or any combination thereof, among other examples.

Player device 106 includes game application 126, model manager 128, and feedback collection engine 130. Player device 106 may be a console gaming system, a mobile device, a smartphone, a personal computer, or any other type of device capable of executing a game locally or accessing a hosted game on a server. Game application 126 may communicate with cloud service 102, which hosts game service 114 (or other type of application associated with a virtual environment). In one example, a game associated with the game service 114 may be hosted directly by the cloud service 102. In an alternate example, player device 106 may host and execute a game locally, in which case the game service 114 may serve as an interface to facilitate communications between one or more computer-controlled agents and the game. It will be appreciated that any of a variety of other virtual environments may be used in other examples.

Player device 106 further includes model manager 128, which may process agent information (e.g., as may be obtained from game agent data store 116) to manage aspects of one or more computer-controlled agents accordingly. In examples, model manager 128 communicates with machine learning service 110 of cloud service 102. For example, model manager 128 may provide a request including agent information, such that cloud service 102 provides model output in response. In examples, model manager 128 provides the model output to game application 126 for further processing (e.g., to affect the appearance and/or behavior of a computer-controlled agent associated therewith). As another example, model manager 128 processes at least a part of the model output to affect the appearance and/or behavior of a computer-controlled agent.

In examples, model manager 128 processes agent information to incorporate user-specific information in addition to more general agent information (e.g., as may have been defined by a developer and/or obtained from cloud service 102), such that model output is generated further based on such additional information. Example user-specific information includes, but is not limited to, virtual environment state information, as well as past interactions between the player and a given computer-controlled agent, one or more player attributes, and/or past decisions made by the player, among other historical information. Similarly, at least a part of the agent information may vary according to a device type, region, and/or locale associated with player device 106, among other device-specific information. As another example, model manager 128 may incorporate background information (e.g., as may be provided by game application 126) into the provided agent information, such that an agent template may be tailored for use with a specific virtual environment.

Model manager 128 may also control branching logic and/or evaluate one or more constraints associated with model output according to aspects described herein. Thus, model manager 128 may enable online dialogue generation to facilitate dynamic interactions between a computer-controlled agent and a user according to aspects of the present disclosure.

Feedback collection engine 130 may generate or otherwise obtain implicit and/or explicit feedback (e.g., based on telemetry data or user input). The feedback may be associated with an instance of agent information and/or model output (e.g., as may have been generated by machine learning service 110). The feedback collected can include information related to the user's playstyle, user communication, user interaction with the game, user interaction with other players, user interaction with other agents, outcomes associated with actions performed by one or more computer-controlled agents in-game, interactions between the player and the computer-controlled agent(s), actions in-game, or any type of information generated by player device 106 as a user plays a game or interacts with any of a variety of other virtual environments. In order to comply with user privacy considerations, information may only be collected by feedback collection engine 130 upon receiving permission from the user to do so. The user may opt in or out of said collection at any time. The data collected may be implicit data, e.g., data based upon the user's normal interactions with the game, or explicit data, such as specific commands provided by the user to the system. An example of a specific command may be the user instructing an agent to address the user by a specific character name. In examples, feedback collection engine 130 may provide an indication of the obtained feedback to machine learning service 110, which may be stored in training data store 118 and/or used to train or update an ML model accordingly.

While system 100 is illustrated as an example in which ML model processing is performed by cloud service 102 and computer-controlled agent behavior is managed by player device 106, it will be appreciated that any of a variety of other paradigms may be used. For example, ML model processing and computer-controlled agent management may be performed locally by player device 106 or remotely by cloud service 102. As another example, a combination of local and remote processing may be used, as may be the case when one computer-controlled agent is player-specific (e.g., for a player of player device 106), while another computer-controlled agent is more generally available (e.g., for a group of players associated with game service 114).

Developer device 104 is illustrated as comprising game development application 120, prompt generator 122, and model manager 124. Aspects of developer device 104 may be similar to player device 106 and are therefore not necessarily redescribed below in detail. It will be appreciated that, in some examples, aspects described herein with respect to developer device 104 may be performed by player device 106, as may be the case when a player also acts as a developer (e.g., to define and/or update aspects of agent information associated with a virtual environment), among other examples.

Game development application 120 is used to define and/or change various aspects of a virtual environment (e.g., as may be associated with game service 114 and game application 126). As an example, game development application 120 may be a development environment for a game engine, though it will be appreciated that any of a variety of software may be used to define/change aspects of a virtual environment. Similarly, game development application 120 need not be a single application but may instead be a suite of applications in other examples.

A developer may use game development application 120 to define and/or change agent information associated with one or more computer-controlled agents of the virtual environment accordingly. For example, the developer may play or otherwise access various aspects of the virtual environment to define and/or modify the appearance and/or behavior of one or more computer-controlled agents associated therewith. Similarly, game development application 120 may be used to manage branching logic and/or associated constraints. Model manager 124 may process agent information for a given computer-controlled agent to affect the computer-controlled agent within the virtual environment according to aspects described herein. Aspects of model manager 124 may be similar to those discussed above with respect to model manager 128 and are therefore not necessarily redescribed below in detail. For example, model manager 124 may communicate with machine learning service 110 to obtain model output with which to control the computer-controlled agent. As noted above, the model output may include dialogue and/or programmatic output (e.g., which may be excited by model manager 124 and/or game development application 120), among other examples.

Prompt generator 122 may be used to generate at least a part of the agent information for a computer-controlled agent of the virtual environment. Prompt generator 122 may receive user input (e.g., indicating at least a part of a prompt) and/or may process implicit/explicit user feedback (e.g., as may be associated with a user of developer device 104 and/or player device 106) to generate prompts accordingly. In some instances, prompt generator 122 may start with a template or other preexisting agent information, as may be associated with an existing computer-controlled agent or obtained from model repository 112. Thus, prompt generator 122 is operable to generate new prompts or instructions based upon the collected feedback or alter existing prompts based upon newly collected feedback, among other examples. It will be appreciated that agent information may be generated using any of a variety of other techniques, for example based solely on manual input (e.g., from a user of device 104 and/or device 106), by one or more machine learning models, or via a combination of various different techniques disclosed herein.

Cloud service 102 is illustrated as including machine learning service 110, model repository 112, game service 114, game agent data store 116, and training data store 118. In examples, machine learning service 110 receives a request from developer device 104 and/or player device 106 (e.g., from model manager 124 and model interaction manager 128, respectively) to generate model output. For example, the request may include an indication of agent information for a given computer-controlled agent. In some instances, the request includes an indication of a model stored by model repository 112 and/or agent information stored by game agent data store 116. Thus, at least a part of the agent information processed by machine learning service 110 may be local to cloud service 102 in some examples. As another example, at least a part of the agent information may be obtained from another data source (not pictured).

Machine learning service 110 may use any number of different models (e.g., individually or in combination). For example, model repository 112 may include foundation models, language models, speech models, video models, and/or audio models may be employed. As used herein, a foundation model is a model trained on broad data that can be adapted to a wide range of tasks (e.g., models capable of processing various different tasks or modalities). As noted above, A/B testing and/or reinforcement learning may be used to finetune model output for a given virtual environment and/or set of users, among other examples. In examples, a multimodal machine learning model of model repository 112 may have been trained using training data having a plurality of content types. Thus, given content of a first type, machine learning service 110 may generate content having any of a variety of associated types. It will be appreciated that model repository 112 may include foundation model as well as models that have been finetuned (e.g., for a specific virtual environment, a specific user or set of users, or a specific type of virtual environment).

Training data store 118 may store training data associated with machine learning service 110. As noted above, training data store 118 may store training data based on feedback generated or otherwise obtained by feedback collection engine 130, such that model performance of models of model repository 112 may be improved as a result of ongoing user interactions with computer-controlled agent interactions that are generated therefrom.

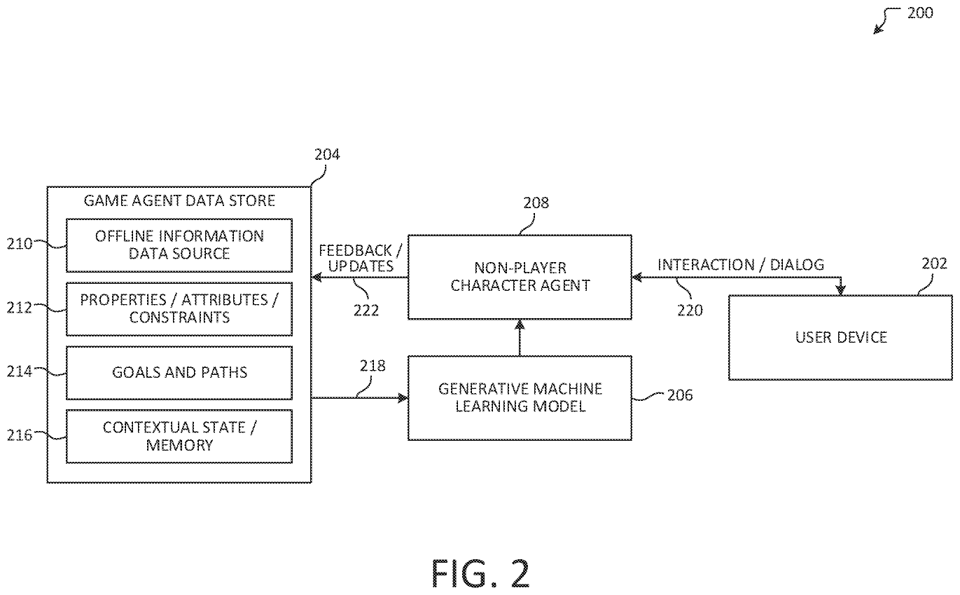

Cloud service 102 further includes game service 114, which may communicate with game application 126 and/or game development application 120. In examples, game service 114 may be used to coordinate multiple instances of a virtual environment, as may be the case when the virtual environment is a multiplayer game. As another example, game service 114 may render at least a part of the virtual environment, which may be provided to developer device 104 and/or player device 106 for display to an associated user. As noted above, game agent data store 116 may store information associated with a given virtual environment (e.g., the virtual environment associated with game service 114, game development application 120, and game application 126), such as agent information and/or information from which agent information may be generated (e.g., background information or historical information). Additional examples are discussed below with respect to game agent data store 204 of FIG. 2.

While cloud service 102 is illustrated as including game service 114 and game agent data store 116, it will be appreciated that, in other examples, at least a part of such aspects may be provided by another computing device (not pictured) or may be performed local to a user's computing device, as may be the case when a virtual environment is an offline game.

FIG. 2 illustrates an overview of an example conceptual diagram 200 for generating machine learning-based dialogue according to aspects described herein. As illustrated, diagram 200 includes user device 202, game agent data store 204, generative machine learning (ML) model 206, and non-player character (NPC) agent 208.

Aspects of game agent data store 204 may be similar to game agent data store 116 and are therefore not necessarily redescribed below in detail. Game agent data store 204 includes offline information data store 210, properties/attributes/constraints 212, goals and paths 214, and contextual state/memory 216, one or more of which may form agent information according to aspects described herein. Additionally, a developer may define and/or change elements 210, 212, 214, and/or 216 of game agent data store 204 to define one or more computer-controlled agents (e.g., using a game development application, such as game development application 120 discussed above with respect to FIG. 1).

As illustrated by arrow 218, agent information from game agent data store 204 is used by generative ML model 206 to generate model output that affects the appearance and/or behavior of NPC agent 208. As noted above, model output of generative ML model 206 may be multimodal output (e.g., as may be generated by a machine learning service, such as machine learning service 110 in FIG. 1), which may include, for example, dialogue and/or programmatic output that is executed to control NPC agent 208 accordingly. NPC agent 208 and user device 202 are thus able to interact, such that a user of user device 202 perceives the resulting behavior of NPC agent 208 within a virtual environment, as indicated by arrow 220. Example interactions include, but are not limited to, dialogue that is provided from NPC agent 208 to a user of user device 202 (e.g., in response to input from a user of user device 202 and/or outbursts or unsolicited dialogue) or non-dialogue interactions such as a player model of NPC agent 208 interacting with a player model of the user, among other interactions. In examples, multiple instances of model output are generated by generative ML model 206, as may be the case when multiple instances of user input are received from user device 202 (e.g., as part of a conversation between an associated user and NPC agent 208).

Feedback/updates associated with NPC agent 208 may be obtained. For example, the feedback received may be explicit. For example, the user may issue a specific command to NPC agent 208 to perform an action or to change the action they are currently performing. Alternatively, or additionally, user feedback may be implicit. Implicit user feedback may be feedback data that is generated based upon user interactions with the game (e.g., as may be generated by a feedback collection engine, such as feedback collection engine 130 in FIG. 1). Thus, arrow 222 is provided to indicate that the received feedback may further affect NPC agent 208, thereby forming a feedback loop between computer-controlled aspects of NPC 208 (e.g., as is defined at least in part by game agent data store 204), generative ML model 206, and the resulting behavior of NPC agent 208. In examples, the feedback may be stored in a training data store, such as training data store 118 in FIG. 1.

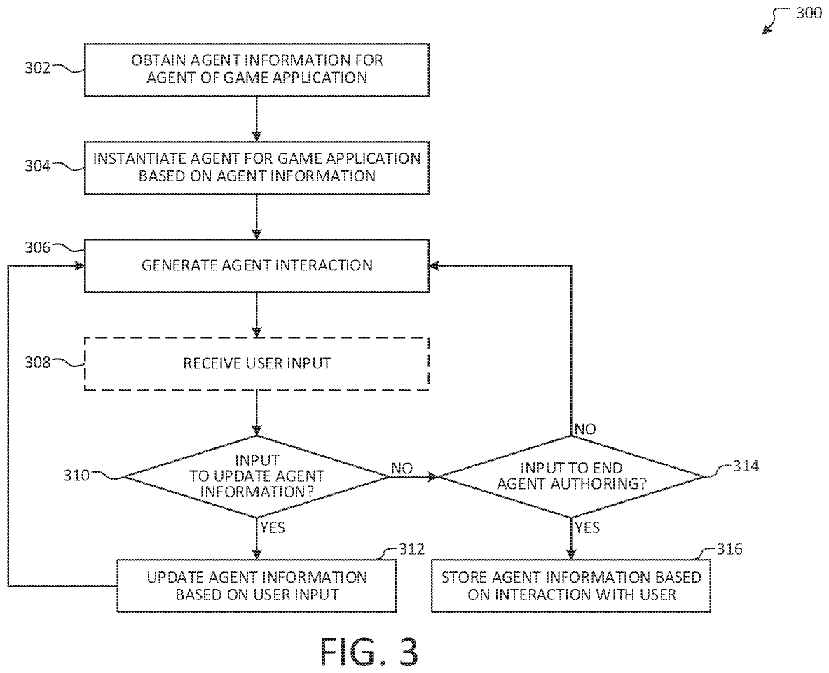

FIG. 3 illustrates an overview of an example method 300 for generating agent information with which to manage an agent of a virtual environment according to aspects described herein. In examples, aspects of method 300 may be performed by a game development application of a developer device, such as game development application 120 of developer device 104 discussed above with respect to FIG. 1. It will be appreciated that similar aspects may be performed by player device or by any of a variety of other devices, as may be the case when a player authors certain aspects of a virtual environment, among other examples.

Method 300 begins at operation 302, where agent information is obtained for a computer-controlled agent of a game application or, in other examples, of any of a variety of other virtual environments. The agent information may include background information associated with a virtual environment and/or preexisting agent information (e.g., as may be associated with an agent template and/or another preexisting computer-controlled agent), as may be obtained from a game agent data store, such as game agent data store 116 or game agent data store 204 in FIGS. 1 and 2, respectively. In other examples, operation 302 may comprise requesting at least a part of the agent information from a user (e.g., using a graphical user interface of a game development application). In some examples, at least a part of the agent information may be generated based on feedback obtained from one or more user devices (e.g., as may be stored by a training data store, such as training data store 118). Thus, it will be appreciated that agent information may be obtained from any of a variety of sources.

At operation 304, a computer-controlled agent is instantiated for the game application based on the obtained agent information. Aspects of operation 304 may be performed by a model manager, such as model manager 124 or 128 in FIG. 1. In one example, the computer-controlled agent may be instantiated in response to receiving a request to add the agent to the virtual environment. In examples, operation 304 comprises providing an indication of at least a part of the agent information to a machine learning service, such as machine learning service 110 of cloud service 102 in FIG. 1. The machine learning service may provide model output in response. In other examples, the agent information may be processed using an ML model locally, thereby obtaining model output from the local ML model. In some examples, operation 304 comprises selecting an ML model from a set of ML models, such that the selected model is thus used to generate model output accordingly. It will therefore be appreciated that any of a variety of techniques may be used to obtain model output based on agent information according to aspects of the present disclosure. Operation 304 may comprise accessing any of a variety of assets associated with the computer-controlled agent, including, but not limited to, a player model, a skin or other texture, and/or one or more associated sounds, among other examples.

Flow progresses to operation 306, where an agent interaction is generated. In examples, operation 306 comprises executing at least a part of the model output that was obtained at operation 304. For example, the agent interaction may comprise providing dialogue of the model output to a user (e.g., in text form and/or as audio). As another example, the agent interaction may include performing a character animation, moving a player model, or changing one or more aspects of a scene with which the computer-controlled agent is associated (e.g., relating to a background audio track, lighting, and/or one or more objects within the virtual environment). While method 300 is illustrated as an example in which the computer-controlled agent provides an initial interaction (e.g., absent direct user input to engage with the computer-controlled agent), it will be appreciated that similar aspects may be used in instances where the computer-controlled agent is engaged in response to explicit and/or implicit user input received from a user.

At operation 308, user input is received. The user input may be explicit and/or implicit user input. For example, the user input may be explicit user input that is directed to the computer-controlled agent, such as spoken and/or textual natural language input that is provided by the user. For example, the natural language output may be used to generate audio output and/or may be presented in association with the computer-controlled agent. As another example, the user input may include an interaction with the player model (or other model associated therewith, such as a weapon or other prop) of the computer-controlled agent within the virtual environment. In some instances, at least a part of the received user input is an implicit user interaction within the virtual environment (e.g., an interaction that is not explicitly directed toward the computer-controlled agent), such as movement of the user's player model within the virtual environment or an interaction with other player models or objects within the virtual environment, among other examples. In other examples, the user input may include an indication to change aspects of the computer-controlled agent, which is discussed in greater detail below.

Thus, it will be appreciated that any of a variety of user inputs may be received in association with an agent interaction that was generated at operation 306. Further, operation 308 is provided using a dashed box to indicate that, in some examples, operation 308 may be omitted, as may be the case when multiple agent interactions are generated prior to the receipt of user input.

At determination 310, it is determined whether the user input is input to update agent information associated with the computer-controlled agent. For example, the input may include a change to one or more agent attributes associated with the agent, such as a change to an agent goal (e.g., adding, removing, or changing a goal), a change to an agent mood, a change to an agent persona, or a change to an agent trait. As another example, the input may include a change to the background information that is used to generate interactions for the computer-controlled agent. As a further example, the update may include an indication to restrict one or more behaviors or other aspects of the computer-controlled agent, thereby indicating that the behavior should be reduced or suppressed in the future (e.g., when the computer-controlled agent is later encountered by a payer).

In some instances, the update may be associated with aspects of the virtual environment, as may be the case when a developer indicates that a goal of the computer-controlled agent is to change in response to a change in the virtual environment or a progression of an associated storyline, among other examples. In other instances, the update may be provided to change a previously observed behavior of the computer-controlled agent, such that a subsequent agent interaction generated at operation 306 is intended to “replay” part of the virtual environment according to the updated agent information. It will therefore be appreciated that an update to agent information may be received for any of a variety of reasons.

If it is determined that the input is to update agent information, flow branches “YES” to operation 312, where agent information is updated based on the user input. In examples, the agent information is updated based on feedback associated with the agent information and associated user input. In other examples, the agent information may be updated based at least in part on additional user input that is received at operation 312 (e.g., via a user interface and/or application that is separate from the virtual environment, such as a game development application). Accordingly, flow returns to operation 306, where a subsequent agent interaction is generated based on the updated agent information. As noted above, the subsequent agent interaction may be intended to replace a previous agent interaction or may be generated to advance a storyline or other aspect of the virtual environment, among other examples.

Returning to determination 310, if it is instead determined that the input is not to update agent information, flow branches “NO” to determination 314, where it is determined whether the input is to end agent authoring. For example, the user input may indicate that the agent is behaving as intended. The user input may be explicit user input (e.g., an interaction with a user interface element or with a computer-controlled agent) or may be implicit user input (e.g., moving away from the computer-controlled agent or changing focus to another computer-controlled agent or other aspect of the virtual environment).

If the user input is not an input to end agent authoring, flow branches “NO” and returns to operation 306, where subsequent model output is generated as discussed above. For example, the subsequent model output may be generated based at least in part on the received user input, as may be the case when the user and the computer-controlled agent are engaged in dialogue or another interaction. However, if the user input is an input to end agent authoring, flow instead branches “YES” to operation 316, the agent information may be stored (e.g., in a game agent data store, such as game agent data store 116 or 204 in FIGS. 1 and 2, respectively). Ultimately, the generated agent information may be used to generate model output for a computer-controlled agent to enable player interaction with the computer-controlled agent in the virtual environment. The agent information may include various portions that are associated with different aspects and/or conditions of the virtual environment (e.g., as may be defined through multiple iterations of operations 306, 308, 310, and/or 312) according to aspects described herein. Method 300 terminates at operation 316.

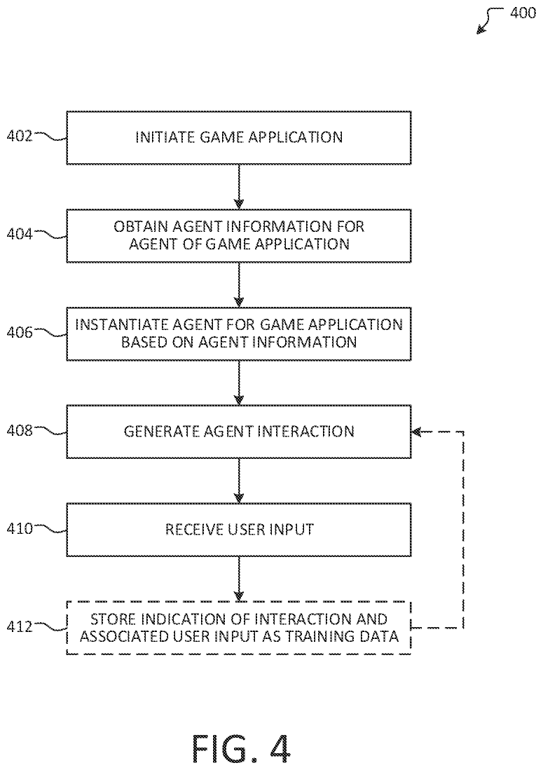

FIG. 4 illustrates an overview of an example method 400 for managing an agent for a virtual environment according to aspects described herein. In examples, aspects of method 400 are performed by a player device, such as player device 106 or user device 202 discussed above with respect to FIGS. 1 and 2, respectively.

As illustrated, method 400 begins at operation 402, where a game application is initiated. For example, the game application may be game application 126 discussed above with respect to FIG. 1. As noted above, processing associated with the game application may be performed locally and/or may be performed remotely by a cloud service (e.g., game service 114 of cloud service 102).

Flow progresses to operation 404, where agent information is obtained for a computer-controlled agent of the game application. In examples, the agent information is obtained from a game agent data store, such as game agent data store 116 or 204 in FIGS. 1 and 2, respectively. As noted above, the agent information may include one or more agent attributes, background information, one or more player attributes, and/or historical information. In some instances, operation 404 includes supplementing the obtained agent information with player-specific information (e.g., including virtual environment state information and/or historical information), thereby enabling the computer-controlled agent to incorporate the state of the virtual environment, past player decisions, and/or interactions in agent interactions that are generated therefrom.

At operation 406, the computer-controlled agent is instantiated for the game application based on the agent information that was obtained at operation 404. Aspects of operation 406 may be performed by a model manager, such as model manager 124 or 128 in FIG. 1. In examples, operation 406 comprises providing an indication of at least a part of the agent information to a machine learning service, such as machine learning service 110 of cloud service 102 in FIG. 1. Model output may be received from the machine learning service in response. In other examples, the agent information may be processed using an ML model locally, thereby obtaining model output from the local ML model. In some examples, operation 406 comprises selecting an ML model from a set of ML models (e.g., as may be associated with the game application that was initiated at operation 402), such that the selected model is thus used to generate model output accordingly. It will therefore be appreciated that any of a variety of techniques may be used to obtain model output based on agent information according to aspects of the present disclosure. In some examples, operation 404 may further comprise accessing any of a variety of assets associated with the computer-controlled agent, including, but not limited to, a player model, a skin or other texture, and/or one or more associated sounds, among other examples.

Flow progresses to operation 408, where an agent interaction is generated. In examples, operation 408 comprises executing at least a part of the model output that was obtained at operation 406. For example, the agent interaction may comprise providing dialogue of the model output to a user (e.g., in text form and/or as audio). As another example, the agent interaction may include performing a character animation, moving a player model, or changing one or more aspects of a scene with which the computer-controlled agent is associated (e.g., relating to a background audio track, lighting, and/or one or more objects within the virtual environment). While method 400 is illustrated as an example in which the computer-controlled agent provides an initial interaction (e.g., absent direct user input to engage with the computer-controlled agent), it will be appreciated that similar aspects may be used in instances where the computer-controlled agent is engaged in response to explicit and/or implicit user input received from a user (e.g., as is discussed below with respect to operation 410).

At operation 410, user input is received. The user input may be explicit and/or implicit user input. For example, the user input may be explicit user input that is directed to the computer-controlled agent, such as spoken and/or textual natural language input that is provided by the user. For example, the natural language output may be used to generate audio output and/or may be presented in association with the computer-controlled agent. As another example, the user input may include an interaction with the player model (or other model associated therewith, such as a weapon or other prop) of the computer-controlled agent within the virtual environment. In some instances, at least a part of the received user input is an implicit user interaction within the virtual environment (e.g., an interaction that is not explicitly directed toward the computer-controlled agent), such as movement of the user's player model within the virtual environment or an interaction with other player models or objects within the virtual environment, among other examples.

Accordingly, at operation 412, an indication of the user interaction that was received at operation 410 and the agent interaction that was generated at operation 408 may be stored as training data. Aspects of operation 412 may be performed by a feedback collection engine, such as feedback collection engine 130 discussed above with respect to FIG. 1. One or more such indications may be used to finetune aspects of the ML model that is used to process agent information with the computer-controlled agent or, as another example, may be used to change the agent information accordingly. As noted above, A/B testing may be used with respect to different instances of agent information, such that an indication generated at operation 412 may be associated with a specific instance of agent information and may thus ultimately be used to distinguish between various instances. In examples, the training data is provided to a cloud service (e.g., cloud service 102), where it may be stored in a training data store (e.g., training data store 118).

Operation 412 is illustrated using a dashed box to indicate that, in some examples, operation 412 may be omitted. For example, aspects of method 400 may be performed separately from feedback generation or feedback generation may be performed after multiple iterations of method 400. A dashed arrow is indicated from operation 412 to operation 408 to indicate that, in some examples, method 400 may loop between operations 408 (e.g., thereby generating subsequent model output with which to control the computer-controlled agent, based on the received user input) and 410 (and, in some examples operation 412), as may be the case when a user engages in repeated interactions with a computer-controlled agent. Method 400 may eventually terminate at operation 410 or operation 412. It will be appreciated that similar aspects may be used in instances where a user first interacts with a computer-controlled agent (e.g., such that operation 410 is performed prior to operation 408). As another example, user input may not be received at operation 410 in some examples, such that operation 410 may be omitted.

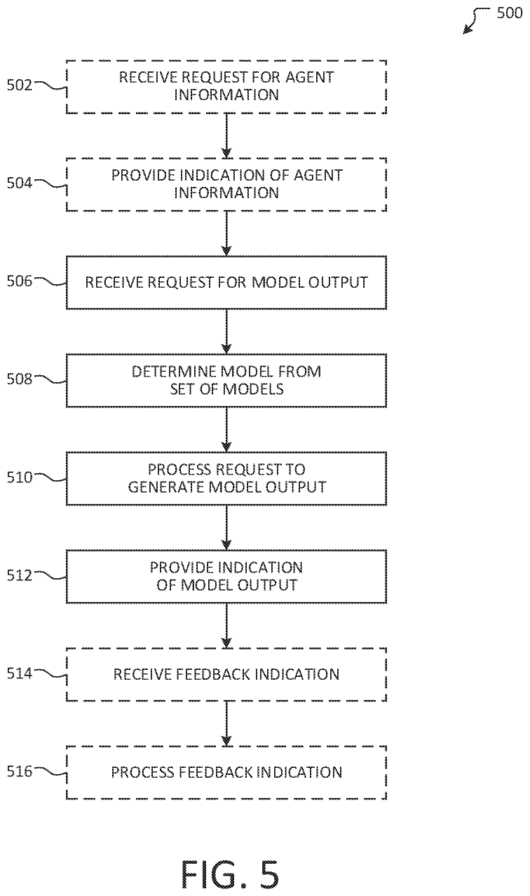

FIG. 5 illustrates an overview of an example method 500 for managing an agent for a virtual environment at a cloud service according to aspects described herein. For example, aspects of method 500 may be performed by cloud service 102 discussed above with respect to FIG. 1.

As illustrated, method 500 begins at operation 502, where a request for agent information is received. In examples, the request comprises an indication of a virtual environment and/or a computer-controlled agent for which the agent information is requested. Accordingly, at operation 504, an indication of the requested agent information is provided. As noted above, A/B testing may be used, such that requests that are similar may receive either a first instance of agent information or a second instance of agent information so as to compare different instances of agent information to one another. The request may be received as a result of a device performing aspects of operation 302 or operation 404 discussed above with respect to method 300 or 400 in FIG. 3 or 4, respectively.

In examples, operation 504 includes generating the agent information from an agent template or from preexisting agent information, as may be the case when a computer-controlled agent from another virtual environment is used or when the agent information is supplemented with player-specific information (e.g., as may be received as part of the request or as may be obtained from a game service, such as game service 114 in FIG. 1). Thus, it will be appreciated that agent information may be obtained from any of a variety of sources and/or processed by any of a variety of computing devices (e.g. at cloud service 102, developer device 104, and/or player device 106) according to aspects described herein.

Operations 502 and 504 are illustrated using dashed boxes to indicate that, in some examples, they may be omitted such that method 500 starts at operation 506. For example, agent information may instead be distributed with a game application and/or may be obtained (e.g., by the game application) from any of a variety of other sources.

At operation 506, a request for model output is received. For example, the request may be received from a model manager, such as model manager 124 or 128 discussed above with respect to FIG. 1. In examples, the request is received as a result of a user computing device (e.g., devices 104 or 106 in FIG. 1) performing aspects of operation 304 or operation 406 discussed above with respect to method 300 or 400 in FIG. 3 or 4, respectively. The request may include an indication of a user interaction and/or agent information for which model output is to be generated.

Accordingly, at operation 508, a model with which to generate the requested model output is determined from a set of models. In examples, the model is determined based on characteristics of a user or user account and/or based on characteristics of a user device, among other examples. As another example, the model may be determined based on a virtual environment associated with the received request, or the request may comprise an indication of a model with which to generate the model output, among other examples.

Flow progresses to operation 510, where the request is processed to generate model output accordingly. For example, the request may be processed by a machine learning service using the model that was determined at operation 508, such as machine learning service 110 of cloud service 102. As noted above, the generated model output may include natural language output, programmatic output, and/or any of a variety of other output types. As another example, the generated model output may additionally or alternatively relate to one or more images, animations, avatars, player models, skins, and/or audio tracks for the computer-controlled agent and/or the virtual environment.

In examples, operation 510 comprises evaluating the model output according to a set of rules, patterns, and/or filters, among other examples. If it is determined that the model output fails to satisfy such constraints, the generated model output may be revised or replacement model output may be generated, among other examples. In other examples, such aspects may be performed client-side and/or such constraints may vary according to a user age or any of a variety of other characteristics associated with the user and/or virtual environment, among other examples.

Flow progresses to operation 512, where an indication of the generated model output is provided in response to the request that was received at operation 506. In examples, method 500 terminates at operation 512. In other examples, method 500 progresses to operation 514, where a feedback indication is received. For example, the indication may be received as a result of a user device performing aspects of operation 312 or 316 of method 300 or operation 412 of method 400.

In instances where a feedback indication is received, the feedback indication is processed at operation 516, for example to store the feedback indication in a training data store (e.g., training data store 118 in FIG. 1), to update agent information (e.g., as may be stored by a game agent data store such as game agent data store 116 or game agent data store 204 in FIG. 2), and/or to retrain or fine tune a model (e.g., as may be stored by a model repository, such as model repository 112). Thus, such reinforcement learning may be used to improve model performance and effectively solidify or otherwise increase the likelihood of certain model outputs (while similarly reducing the likelihood of other model outputs). Method 500 may then terminate at operation 516.

It will be appreciated that, while aspects of method 300, 400, and 500 are described in the context of a user device or a cloud service, such aspects may be performed by any of a variety of devices. For example, aspects of method 300, 400, and 500 may be performed by the same computing device, as may be the case when a user acts as both a developer and a player and, further, the computer-controlled agent is managed locally.

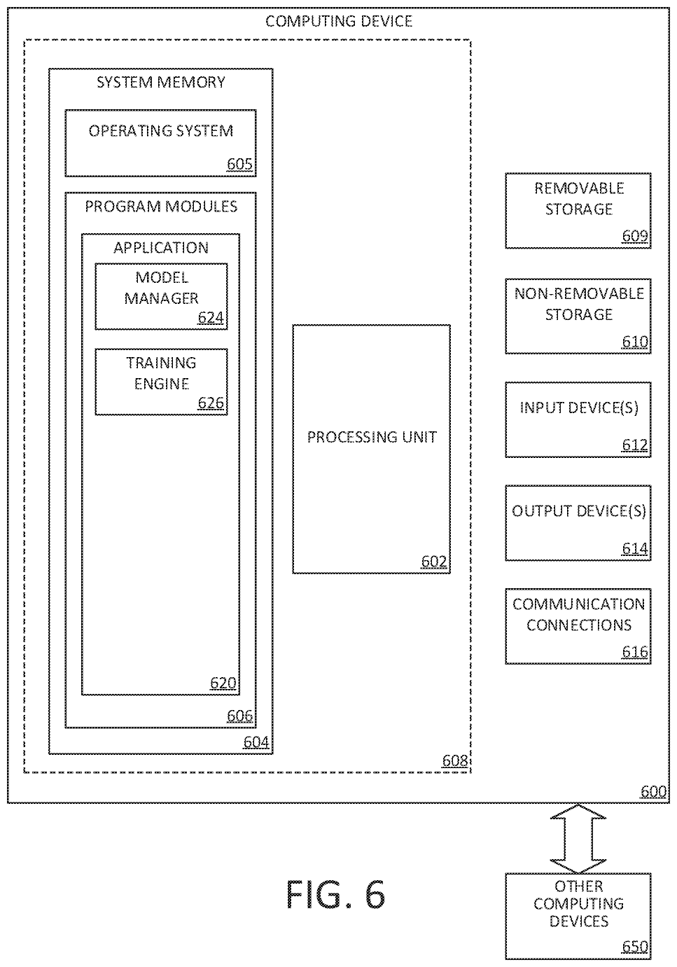

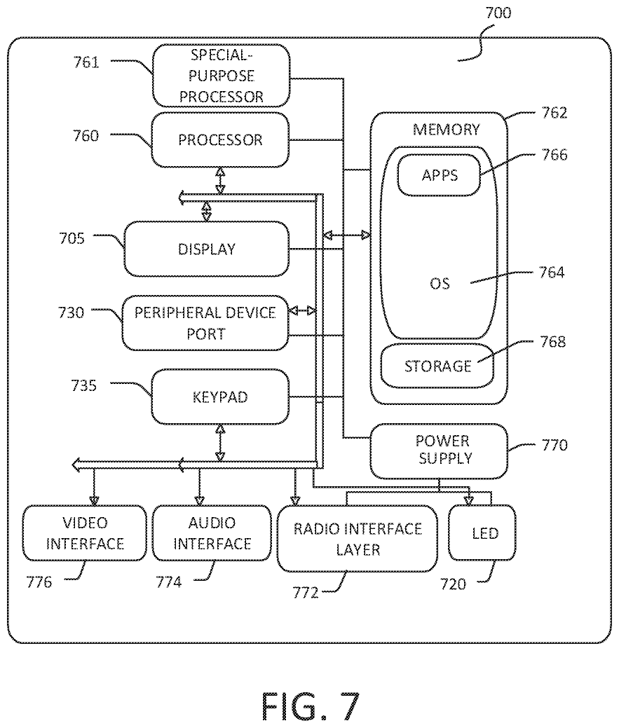

FIGS. 6 and 7 and the associated descriptions provide a discussion of a variety of operating environments in which aspects of the disclosure may be practiced. However, the devices and systems illustrated and discussed with respect to FIGS. 6 and 7 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above, including one or more devices associated with cloud service 102, as well as developer device 104 or player device 106 discussed above with respect to FIG. 1. In a basic configuration, the computing device 600 may include at least one processing unit 602 and a system memory 604.

Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may store model manager 624 and training engine 626. The operating system 605, for example, may be suitable for controlling the operation of the computing device 600.

Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., application 620) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIG. 7 illustrates a system 700 that may, for example, be a mobile computing device, such as a mobile telephone, a smart phone, wearable computer (such as a smart watch), a tablet computer, a laptop computer, and the like, with which embodiments of the disclosure may be practiced. In one embodiment, the system 700 is implemented as a “smart phone” capable of running one or more applications (e.g., browser, e-mail, calendaring, contact managers, messaging clients, games, and media clients/players). In some aspects, the system 700 is integrated as a computing device, such as an integrated personal digital assistant (PDA) and wireless phone.

In a basic configuration, such a mobile computing device is a handheld computer having both input elements and output elements. The system 700 typically includes a display 705 and one or more input buttons that allow the user to enter information into the system 700. The display 705 may also function as an input device (e.g., a touch screen display).

If included, an optional side input element allows further user input. For example, the side input element may be a rotary switch, a button, or any other type of manual input element. In alternative aspects, system 700 may incorporate more or less input elements. For example, the display 705 may not be a touch screen in some embodiments. In another example, an optional keypad 735 may also be included, which may be a physical keypad or a “soft” keypad generated on the touch screen display.

In various embodiments, the output elements include the display 705 for showing a graphical user interface (GUI), a visual indicator (e.g., a light emitting diode 720), and/or an audio transducer 725 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 700 also includes a non-volatile storage area 768 within the memory 762. The non-volatile storage area 768 may be used to store persistent information that should not be lost if the system 700 is powered down. The application programs 766 may use and store information in the non-volatile storage area 768, such as e-mail or other messages used by an e-mail application, and the like. A synchronization application (not shown) also resides on the system 700 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the system 700 described herein.

The system 700 has a power supply 770, which may be implemented as one or more batteries. The power supply 770 might further include an external power source, such as an AC adapter or a powered docking cradle that supplements or recharges the batteries.

The system 700 may also include a radio interface layer 772 that performs the function of transmitting and receiving radio frequency communications. The radio interface layer 772 facilitates wireless connectivity between the system 700 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 700 may further include a video interface 776 that enables an operation of an on-board camera 730 to record still images, video stream, and the like.

It will be appreciated that system 700 may have additional features or functionality. For example, system 700 may also include additional data storage devices (removable and/or non-removable) such as, magnetic disks, optical disks, or tape. Such additional storage is illustrated in FIG. 7 by the non-volatile storage area 768.

Data/information generated or captured and stored via the system 700 may be stored locally, as described above, or the data may be stored on any number of storage media that may be accessed by the device via the radio interface layer 772 or via a wired connection between the system 700 and a separate computing device associated with the system 700, for example, a server computer in a distributed computing network, such as the Internet. As should be appreciated, such data/information may be accessed via the radio interface layer 772 or via a distributed computing network. Similarly, such data/information may be readily transferred between computing devices for storage and use according to any of a variety of data/information transfer and storage means, including electronic mail and collaborative data/information sharing systems.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

As will be understood from the foregoing disclosure, one aspect of the technology relates to a system comprising: at least one processor; and memory storing instructions that, when executed by the at least one processor, cause the system to perform a set of operations. The set of operations comprises: identifying user input of a user, wherein the user input is associated with a computer-controlled agent of a virtual environment; generating, based on the user input and agent information associated with the computer-controlled agent, model output associated with a multimodal machine learning model; and executing at least a part of the model output to control the computer-controlled agent within the virtual environment. In an example, the set of operations further comprises: receiving, from the user, an indication to change at least a part of the agent information based a behavior of the computer-controlled agent associated with the model output; updating the agent information based the received indication to generate updated agent information; generating replacement model output based on the updated agent information; and executing at least a part of the replacement model output to control the computer-controlled agent within the virtual environment. In another example, the agent information comprises a set of agent attributes that define one or more of: a trait of the computer-controlled agent; a persona of the computer-controlled agent; a goal of the computer-controlled agent; or a mood of the computer-controlled agent. In a further example, the agent information comprises at least one of: background information associated with the virtual environment; historical information associated with the user; a set of attributes associated with the user; or virtual environment state information for the virtual environment. In yet another example, the set of operations further comprises: evaluating, prior to executing the part of the model output, the model output according to a set of constraints to determine whether to present the model output to the user; based on determining not to present the model output to the user: generating replacement model output for the user input; and executing the replacement model output as the part of the model output. In a further still example, the set of operations further comprises generating an indication of feedback associated with the model output, wherein the indication of feedback is used to finetune the multimodal machine learning model using reinforcement learning. In another example, generating the model output comprises: providing, to a machine learning service, an indication of the user input in association with the agent information; and receiving, from the machine learning service, the model output.

In another aspect, the technology relates to a method. The method comprises: generating, based agent information associated with a computer-controlled agent of a virtual environment, model output associated with a multimodal machine learning model; controlling the computer-controlled agent within the virtual environment based on the generated model output; receiving, from a user, an indication to change at least a part of the agent information based a behavior of the computer-controlled agent associated with the model output; updating the agent information based the received indication to generate updated agent information; generating replacement model output based on the updated agent information; and controlling the computer-controlled agent within the virtual environment based on the replacement model output. In an example, the method further comprises storing the updated agent information in a game agent data store for use in controlling a computer-controlled agent in an interaction with a player of the virtual environment. In another example, the indication to change at least a part of the agent information is received as a change to a prompt of the agent information. In a further example, the indication to change at least a part of the agent information comprises a change to a set of constraints for the computer-controlled agent. In yet another example, the agent information comprises a set of agent attributes that define one or more of: a trait of the computer-controlled agent; a persona of the computer-controlled agent; a goal of the computer-controlled agent; or a mood of the computer-controlled agent. In a further still example, the agent information comprises at least one of: background information associated with the virtual environment; historical information associated with the player; a set of attributes associated with the player; or virtual environment state information for the virtual environment.

In a further aspect, the technology relates to a method. The method comprises: identifying user input of a player, wherein the user input is associated with a computer-controlled agent of a game application; generating, based on the user input and agent information associated with the computer-controlled agent, model output associated with a multimodal machine learning model; and controlling the computer-controlled agent within the game application based on the generated model output, thereby causing the computer-controlled agent to interact with the player. In an example, the agent information comprises a set of agent attributes that define one or more of: a trait of the computer-controlled agent; a persona of the computer-controlled agent; a goal of the computer-controlled agent; or a mood of the computer-controlled agent. In another example, the agent information comprises at least one of: background information associated with the virtual environment; historical information associated with the player; a set of attributes associated with the player; or virtual environment state information for the virtual environment. In a further example, the model output is initial model output and the method further comprises: evaluating, prior to executing the part of the model output, the model output according to a set of constraints to determine whether to present the model output to the player; based on determining not to present the model output to the player: generating replacement model output for the user input; and controlling the computer-controlled agent based on the replacement model output instead of the initial model output. In yet another example, the method further comprises generating an indication of feedback associated with the model output, wherein the indication of feedback is used to finetune the multimodal machine learning model using reinforcement learning. In a further still example, generating the model output comprises: providing, to a machine learning service, an indication of the user input in association with the agent information; and receiving, from the machine learning service, the model output. In another example, controlling the computer-controlled agent based on the model output comprises one or more of: executing programmatic output of the model output to control the computer-controlled agent; displaying natural language output of the model output in association with the computer-controlled agent; or generating audio output for the computer-controlled agent based on the natural language output of the model output.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
identifying user input of a user, wherein the user input is associated with a computer-controlled agent of a virtual environment;
generating, based on the user input and agent information associated with the computer-controlled agent, model output associated with a multimodal machine learning model; and
executing at least a part of the model output to control the computer-controlled agent within the virtual environment.

2. The system of claim 1, wherein the set of operations further comprises:
receiving, from the user, an indication to change at least a part of the agent information based a behavior of the computer-controlled agent associated with the model output;
updating the agent information based the received indication to generate updated agent information;
generating replacement model output based on the updated agent information; and
executing at least a part of the replacement model output to control the computer-controlled agent within the virtual environment.

3. The system of claim 1, wherein the agent information comprises a set of agent attributes that define one or more of:
a trait of the computer-controlled agent;
a persona of the computer-controlled agent;
a goal of the computer-controlled agent; or
a mood of the computer-controlled agent.

4. The system of claim 1, wherein the agent information comprises at least one of:
background information associated with the virtual environment;
historical information associated with the user;
a set of attributes associated with the user; or
virtual environment state information for the virtual environment.

5. The system of claim 1, wherein the set of operations further comprises:
evaluating, prior to executing the part of the model output, the model output according to a set of constraints to determine whether to present the model output to the user;
based on determining not to present the model output to the user:
generating replacement model output for the user input; and
executing the replacement model output as the part of the model output.

6. The system of claim 1, wherein the set of operations further comprises generating an indication of feedback associated with the model output, wherein the indication of feedback is used to finetune the multimodal machine learning model using reinforcement learning.

7. The system of claim 1, wherein generating the model output comprises:
providing, to a machine learning service, an indication of the user input in association with the agent information; and
receiving, from the machine learning service, the model output.

8. A method, comprising:
generating, based agent information associated with a computer-controlled agent of a virtual environment, model output associated with a multimodal machine learning model;
controlling the computer-controlled agent within the virtual environment based on the generated model output;
receiving, from a user, an indication to change at least a part of the agent information based a behavior of the computer-controlled agent associated with the model output;
updating the agent information based the received indication to generate updated agent information;
generating replacement model output based on the updated agent information; and
controlling the computer-controlled agent within the virtual environment based on the replacement model output.

9. The method of claim 8, further comprising storing the updated agent information in a game agent data store for use in controlling a computer-controlled agent in an interaction with a player of the virtual environment.

10. The method of claim 8, wherein the indication to change at least a part of the agent information is received as a change to a prompt of the agent information.

11. The method of claim 8, wherein the indication to change at least a part of the agent information comprises a change to a set of constraints for the computer-controlled agent.

12. The method of claim 8, wherein the agent information comprises a set of agent attributes that define one or more of:
a trait of the computer-controlled agent;
a persona of the computer-controlled agent;
a goal of the computer-controlled agent; or
a mood of the computer-controlled agent.

13. The method of claim 8, wherein the agent information comprises at least one of:
background information associated with the virtual environment;
historical information associated with the player;
a set of attributes associated with the player; or
virtual environment state information for the virtual environment.

14. A method, comprising:
identifying user input of a player, wherein the user input is associated with a computer-controlled agent of a game application;
generating, based on the user input and agent information associated with the computer-controlled agent, model output associated with a multimodal machine learning model; and
controlling the computer-controlled agent within the game application based on the generated model output, thereby causing the computer-controlled agent to interact with the player.

15. The method of claim 14, wherein the agent information comprises a set of agent attributes that define one or more of:
a trait of the computer-controlled agent;
a persona of the computer-controlled agent;
a goal of the computer-controlled agent; or
a mood of the computer-controlled agent.

16. The method of claim 14, wherein the agent information comprises at least one of:
background information associated with the virtual environment;
historical information associated with the player;
a set of attributes associated with the player; or
virtual environment state information for the virtual environment.

17. The method of claim 14, wherein the model output is initial model output and the method further comprises:
evaluating, prior to executing the part of the model output, the model output according to a set of constraints to determine whether to present the model output to the player;
based on determining not to present the model output to the player:
generating replacement model output for the user input; and
controlling the computer-controlled agent based on the replacement model output instead of the initial model output.

18. The method of claim 14, further comprising generating an indication of feedback associated with the model output, wherein the indication of feedback is used to finetune the multimodal machine learning model using reinforcement learning.

19. The method of claim 14, wherein generating the model output comprises:
providing, to a machine learning service, an indication of the user input in association with the agent information; and
receiving, from the machine learning service, the model output.

20. The method of claim 14, wherein controlling the computer-controlled agent based on the model output comprises one or more of:
executing programmatic output of the model output to control the computer-controlled agent;
displaying natural language output of the model output in association with the computer-controlled agent; or
generating audio output for the computer-controlled agent based on the natural language output of the model output.
